(19) United States
(12) Patent Application Publication
(10) Pub. No.: US 2017/0147182 A1
(43) Pub. Date: May 25, 2017

(54) TECHNIQUES TO REMOTELY CONFIGURE INTERFACE SETTINGS

(71) Applicant: Facebook, Inc., Menlo Park, CA (US)

(72) Inventors: Peter Henry Martinazzi, Huntington Beach, CA (US); Richard Kenneth Zadorozny, Menlo Park, CA (US); Jennifer A. Burge, Oakland, CA (US); Xiao Ou Wang, San Francisco, CA (US); Benjamin Eric Hiller, Menlo Park, CA (US)

(73) Assignee: Facebook, Inc., Menlo Park, CA (US)

(21) Appl. No.: 14/951,666

(22) Filed: Nov. 25, 2015

(51) Int. Cl. G06F 3/0481; H04L 29/08; G06F 3/0484; H04L 12/58

(52) U.S. Cl. CPC G06F 3/04817; H04L 51/16; H04L 67/306; H04L 51/04; H04L 67/02; G06F 3/04847

(57) ABSTRACT

Techniques to remotely configure interface settings for messaging clients are described. In one embodiment, an apparatus may comprise a messaging component operative to receive a user interface configuration object at a first messaging client on the first client device, the first messaging client on the first client device associated with a first user account with a messaging system, the user interface configuration object indicating a user interface setting specified at a second messaging client on a second client device, the second messaging client on the second client device associated with a second user account with the messaging system; and a user interface component operative to store the user interface setting in association with a message thread associated with the first user account and the second user account; and display a message thread interface for the message thread based on the user interface setting. Other embodiments are described and claimed.

### BACKGROUND

Users may interact with each other in a messaging system, sending messages back and forth to each other in a text-based conversation between two or more users. A user may have a user account associated with them in the messaging system, the user account providing an online identity for the user, a destination for messages directed to the user, and generally coordinating the user's access to and use of the messaging system. A user may access the messaging system from a variety of endpoints, including mobile devices (e.g., cellphones), desktop computers, web browsers, specialized messaging clients, etc.

### SUMMARY

The following presents a simplified summary in order to provide a basic understanding of some novel embodiments described herein. This summary is not an extensive overview, and it is not intended to identify key/critical elements or to delineate the scope thereof. Some concepts are presented in a simplified form as a prelude to the more detailed description that is presented later.

Various embodiments are generally directed to techniques to remotely configure interface settings. Some embodiments are particularly directed to techniques to remotely configure interface settings for messaging clients. In one embodiment, for example, an apparatus may comprise a messaging component operative to receive a user interface configuration object from a messaging system at a first messaging client on the first client device, the first messaging client on the first client device associated with a first user account with the messaging system, the user interface configuration object indicating a user interface setting specified at a second messaging client on a second client device, the second messaging client on the second client device associated with a second user account with the messaging system; and a user interface component operative to store the user interface setting in association with a message thread associated with the first user account and the second user account; and display a message thread interface for the message thread based on the user interface setting. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a display configuration system.

FIG. 2 illustrates an example of a social graph.

FIG. 3 illustrates an embodiment of a user interface for a message thread.

FIG. 4 illustrates an embodiment of a user interface displaying user interface configuration controls.

FIG. 5 illustrates an embodiment of a user interface for a message thread with a customized social approval icon.

FIG. 6 illustrates an embodiment of a user interface for a group message thread with a customized social approval icon and customized nickname.

FIG. 7 illustrates an embodiment of a display configuration system transferring a user interface configuration setting between client devices.

FIG. 8 illustrates an embodiment of a logic flow for the system of FIG. 1.

FIG. 9 illustrates an embodiment of a centralized system for the system of FIG. 1.

FIG. 10 illustrates an embodiment of a distributed system for the system of FIG. 1.

FIG. 11 illustrates an embodiment of a computing architecture.

FIG. 12 illustrates an embodiment of a communications architecture.

FIG. 13 illustrates an embodiment of a radio device architecture.

### DETAILED DESCRIPTION

Messaging interactions mediated by a messaging system may be organized into virtual shared spaces known as message threads. A message thread may collect together the messages shared between a particular group of users. Messages sent individually between a pair of users may be collected into a one-on-one message thread uniquely associated with the private messaging between the pair of users. Messages sent between a group of three or more users may not be uniquely defined by their membership, but instead by, in some embodiments, an identifier uniquely identifying the group thread. Membership in a group thread may, in some embodiments, vary over time, adding and/or losing members.

The impression of a message thread as a virtual shared space may be increased by allowing common and shared user interface settings for the message thread. User interface settings such as the background color, bubble color, icon preferences, or nicknames may be specified, with these user interface settings specific to a thread and shared among all messaging clients engaged with the thread and only used for configuring that thread. Any participant in the thread may make changes and see their changes distributed across all of the messaging clients engaged in a particular thread. As a result, the embodiment can improve the customizability of the messaging experience for users of a messaging system in a manner that serves to treat a message thread as a shared space for its participants.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

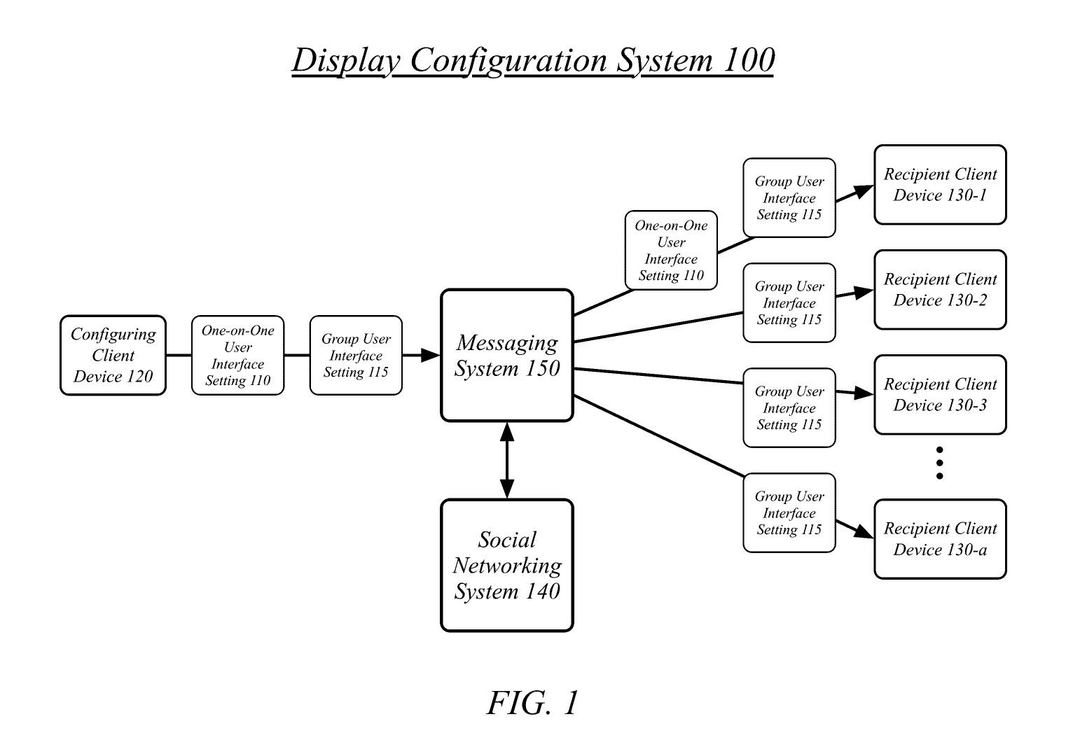

FIG. 1 illustrates a block diagram for a display configuration system 100. In one embodiment, the display configuration system 100 may comprise a computer-implemented system having software applications comprising one or more components. Although the display configuration system 100 shown in FIG. 1 has a limited number of elements in a certain topology, it may be appreciated that the display configuration system 100 may include more or less elements in alternate topologies as desired for a given implementation.

A messaging system 150 may be generally arranged to receive, store, and deliver messages. The messaging system 150 may store messages while messaging clients, such as may execute on configuring client device 120 and recipient client device 130, are offline and deliver the messages once the messaging clients are available.

Client devices 120, 130 may execute messaging clients for the messaging system 150, wherein each of the client devices 120, 130 and their respective messaging clients are associated with a particular user of the messaging system 150. In some embodiments, the client devices 120, 130 may be cellular devices such as smartphones and may be identified to the messaging system 150 based on a phone number associated with each of the client devices 120, 130. In some embodiments, the client devices 120, 130 may be identified to the messaging system 150 based on a user account registered with the messaging system 150—and potentially a social networking system 140 that comprises or is associated with the messaging system 150—and logged into from the messaging client executing on the client devices 120, 130. In general, each messaging client may be addressed through various techniques for the reception of messages. While in some embodiments the client devices 120, 130 may comprise cellular devices, in other embodiments one or more of the client devices 120, 130 may include personal computers, tablet devices, any other form of computing device without limitation. Personal computers and other devices may access a messaging system 150 using web browser accessing a web server, for instance.

Messages exchanged by the messaging system 150 may be organized by threads. A thread may correspond to a particular collection of messages, wherein at any particular point in time the thread is associated with a particular group of users, such as a pair of users in a one-on-one thread or three or more users in a group thread. A configuring client device 120 may engaged in a one-on-one conversation with a particular recipient client device 130-1. It will be appreciated that the configuring client device 120 may also engage in a one-on-one conversation with a second, or additional, client devices, but that these would be distinct one-on-one messaging conversations from each other.

The user of the configuring client device 120 may configure various user interface settings for message threads with which it is engaged. It will be appreciated that the description of the configuring client device 120 as the “configuring” client device refers to its position within the description of the embodiments herein, and that any client device engaged in a message thread, including the recipient client device 130, may empower their user to configure user interface settings for message threads. The configuring client device 120 may receive user instructions to configure a one-on-one user interface setting 110 for a one-on-one message thread and, in response to the user instructions, transmit the one-on-one user interface setting 110 to a single recipient client device 110-1 associated with the other user in the one-on-one message thread via the messaging system 150. The configuring client device 120 may receive user instructions to configure a group user interface setting 115 for a group message thread and, in response to the user instructions, transmit the group user interface setting 115 to a plurality of recipient client devices 130, where each of the recipient client device 130 are associated with other users in the group message thread, via the messaging system 150. A recipient client device may receive a one-on-one user interface setting 110 or a group user interface setting 115 and apply the received user interface setting 110, 115 to the user interface for the respective message thread.

The display configuration system 100 may use knowledge generated from interactions in between users. The display configuration system 100 may comprise a component of a social-networking system 140 and may use knowledge generated from the broader interactions of the social-networking system 140. As such, to protect the privacy of the users of the display configuration system 100 and the larger social-networking system 140, display configuration system 100 may include an authorization server (or other suitable component(s)) that allows users to opt in to or opt out of having their actions logged by the display configuration system 100 or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of the display configuration system 100 and other elements of a social-networking system 140 through blocking, data hashing, anonymization, or other suitable techniques as appropriate. For example, while interactions between users of a social-networking system 140 and the social-networking system 140 may be used to learn media content preferences and the relationship between preferences for different pieces of media content, these interactions may be anonymized prior to or as part of the learning process.

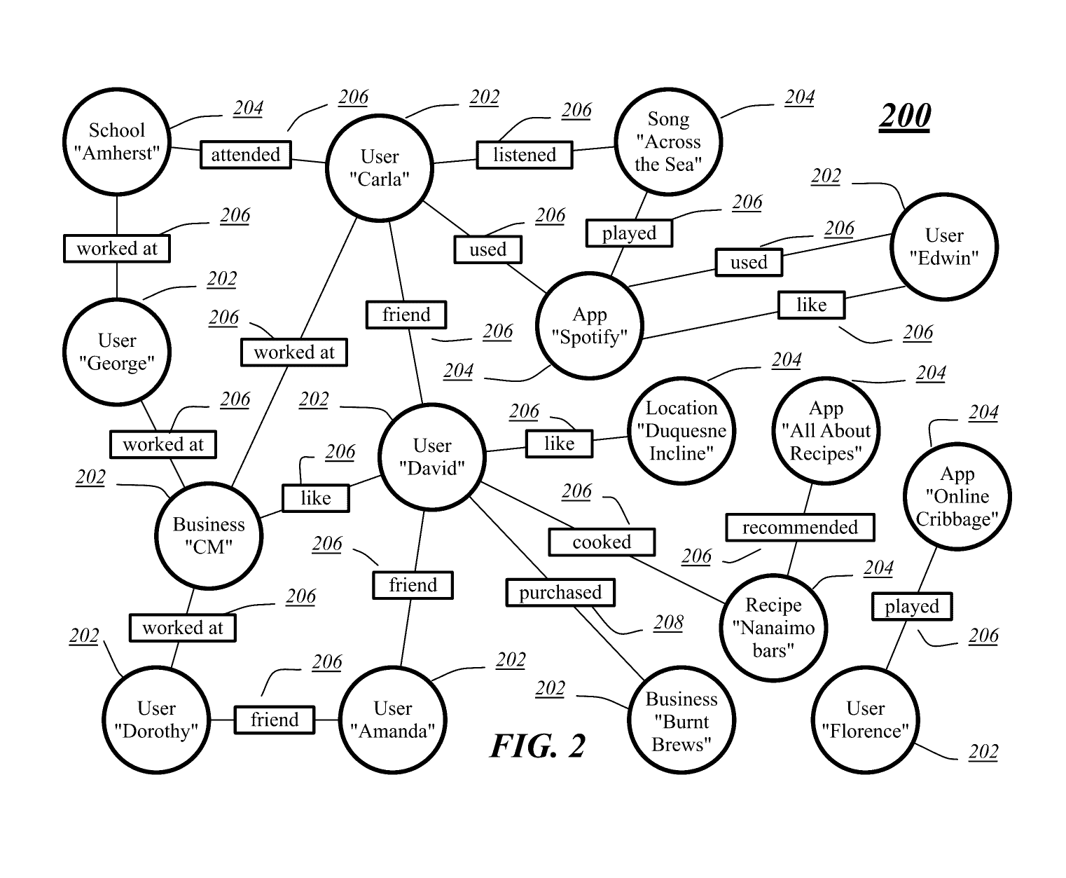

FIG. 2 illustrates an example of a social graph 200. In particular embodiments, a social-networking system 140 may store one or more social graphs 200 in one or more data stores as a social graph data structure via the social networking service 170.

In particular embodiments, social graph 200 may include multiple nodes, which may include multiple user nodes 202 and multiple concept nodes 204. Social graph 200 may include multiple edges 206 connecting the nodes. In particular embodiments, a social-networking system 140, client system, third-party system, or any other system or device may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of the social-networking system 140. As an example and not by way of limitation, a user may be an individual (human user), an entity (e.g., an enterprise, business, or third-party application), or a group (e.g., of individuals or entities) that interacts or communicates with or over the social-networking system 140. In particular embodiments, when a user registers for an account with the social-networking system 140, the social-networking system 140 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 140. In particular embodiments, a user node 202 may be associated with information provided by a user or information gathered by various systems, including the social-networking system 140. As an example and not by way of limitation, a user may provide their name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages. A user node 202 may be associated with a unique user identifier for the user in the social-networking system 140.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system 140 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 140. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to the social-networking system 140. Profile pages may also be hosted on third-party websites associated with a third-party server. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. A business page such as business page 205 may comprise a user-profile page for a commerce entity. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system 140 a message indicating the user's action. In response to the message, the social-networking system 140 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 140 may send a “friend request” to the second user. If the second user confirms the “friend request,” the social-networking system 140 may create an edge 206 connecting the first user's user node 202 to the second user's user node 202 in social graph 200 and store edge 206 as social-graph information in one or more data stores. In the example of FIG. 2, social graph 200 includes an edge 206 indicating a friend relation between user nodes 202 of user “Amanda” and user “Dorothy.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, the social-networking system 140 may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking system 140 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 140 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Across the Sea”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “Edwin” and concept node 204 for “SPOTIFY”).

In particular embodiments, the social-networking system 140 may create an edge 206 between a user node 202 and a concept node 204 in social graph 200. As an example and not by way of limitation, a user viewing a concept-profile page (such as, for example, by using a web browser or a special-purpose application hosted by the user's client system) may indicate that he or she likes the concept represented by the concept node 204 by clicking or selecting a “Like” icon, which may cause the user's client system to send to the social-networking system 140 a message indicating the user's liking of the concept associated with the concept-profile page. In response to the message, the social-networking system 140 may create an edge 206 between user node 202 associated with the user and concept node 204, as illustrated by “like” edge 206 between the user and concept node 204. In particular embodiments, the social-networking system 140 may store an edge 206 in one or more data stores. In particular embodiments, an edge 206 may be automatically formed by the social-networking system 140 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

The social graph 200 may further comprise a plurality of product nodes. Product nodes may represent particular products that may be associated with a particular business. A business may provide a product catalog to the consumer-to-business service 110 and the consumer-to-business service 110 may therefore represent each of the products within the product in the social graph 200 with each product being in a distinct product node. A product node may comprise information relating to the product, such as pricing information, descriptive information, manufacturer information, availability information, and other relevant information. For example, each of the items on a menu for a restaurant may be represented within the social graph 200 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 200. The information for a product node may be manipulated by the social-networking system 140 as a product object that encapsulates information regarding the referenced product.

As such, the social graph 200 may be used to infer shared interests, shared experiences, or other shared or common attributes of two or more users of a social-networking system 140. For instance, two or more users each having an edge to a common business, product, media item, institution, or other entity represented in the social graph 200 may indicate a shared relationship with that entity, which may be used to suggest customization of a use of a social-networking system 140, including a messaging system 150, for one or more users.

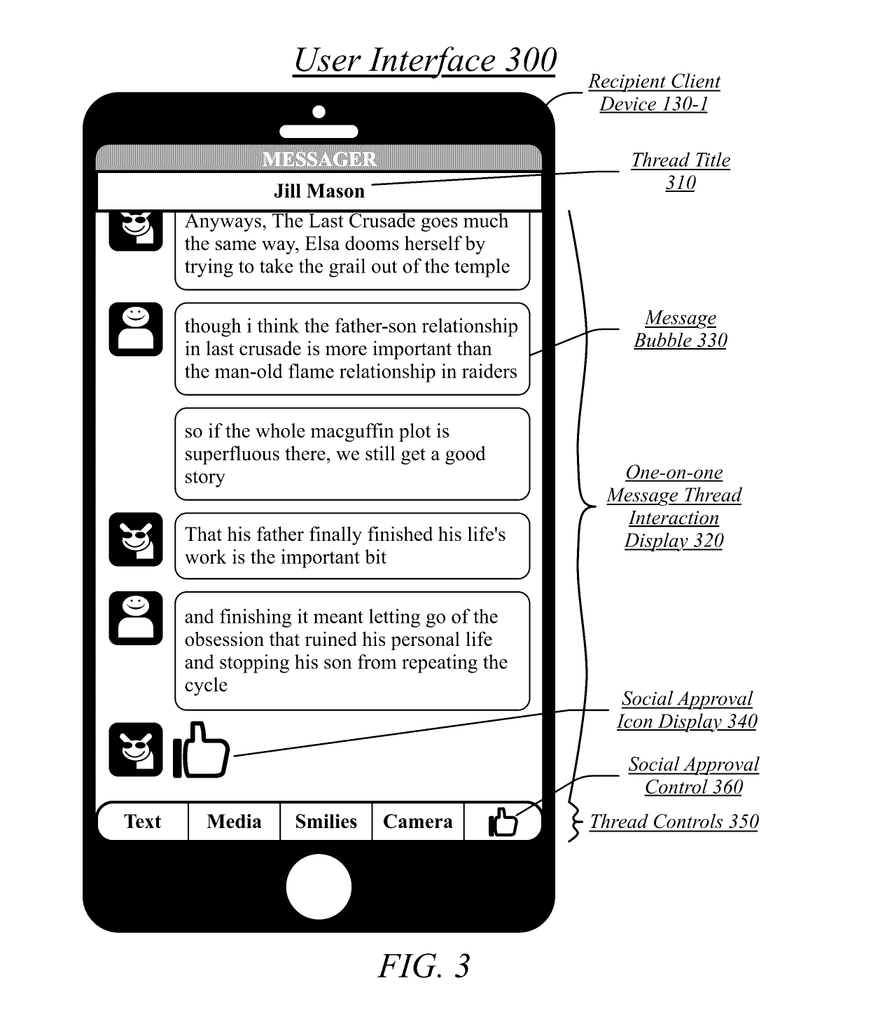

FIG. 3 illustrates an embodiment of a user interface 300 for a message thread.

The user interface 300 may comprise a user interface for a one-on-one message thread. At least a portion of the message exchange for the message thread may be displayed in a one-on-one message thread interaction display 320. A one-on-one message thread interaction display 320 may comprise a display of one or more messages exchanged by the users of the one-on-one message thread.

Each of the one or more messages may be represented by a particular message bubble, such as message bubble 330. A message bubble may represent an atomic messaging interaction. A message bubble may generally correspond to a defined geometric area in which the contents of a particular messaging exchange (e.g., text, media) are contained within the defined geometric area. A message bubble may have a distinct color or plurality of colors (e.g., one or more gradients) that distinguish it from a background of a message thread interaction display. A message bubble may have a distinctly-colored border, such as a black outline as depicted, or may have a border defined by the interface between differing colors of the message bubble and the background. In some embodiments, the color or colors of either or both the message bubbles and the background may be customized and configured by users of the display configuration system 100.

The messaging system 150 may promote the use of a social approval icon, such as a thumbs-up (as depicted in FIG. 3), check mark, or other visual representation or image. A social approval icon may be used to, without limitation, indicate approval, understanding, acceptance, or other general positive reaction. The use of a social approval icon by the messaging system 150 may empower quick responses using a single button or screen press where simple acceptance is all that the user messaging needs or desires to indicate. However, while the illustrated embodiments specifically illustrate the customization of a social approval icon, any icons, symbols, images, or other elements of a thread may be customized.

The user interface 300 for a message thread may include thread controls 350 that are persistently visible during the display of a message thread. Many, most, or nearly all of the thread controls 350 may empower access to further user interface controls for the performance of various tasks, such as text entry, media selection, emoji selection, camera use, etc. However, some controls—and in some embodiments precisely one of the thread controls 350—empower the immediate sending of a single icon, such as the social approval icon. The thread controls 350 may comprise a social approval control 360 empowering the sending of a message communicating the use of the social approval icon, resulting in both the local and remote display of a social approval icon display 340 displaying the social approval icon. In some embodiment, the social approval control 360 may comprise the only control of the text controls 360 that, if activated by the user, results in the immediate generation of a message and that, more specifically, results in the immediate generation of a message communicating the use of a single icon. In some embodiments, the social approval icon may be customized for a particular message thread.

The user interface 300 may include a thread title 300 listing one or more other users involved in the thread. The thread title 300 may automatically use the name of a user, such as a full name, short name, or other name registered as the name for use with a particular user for messaging and/or social-networking interactions.

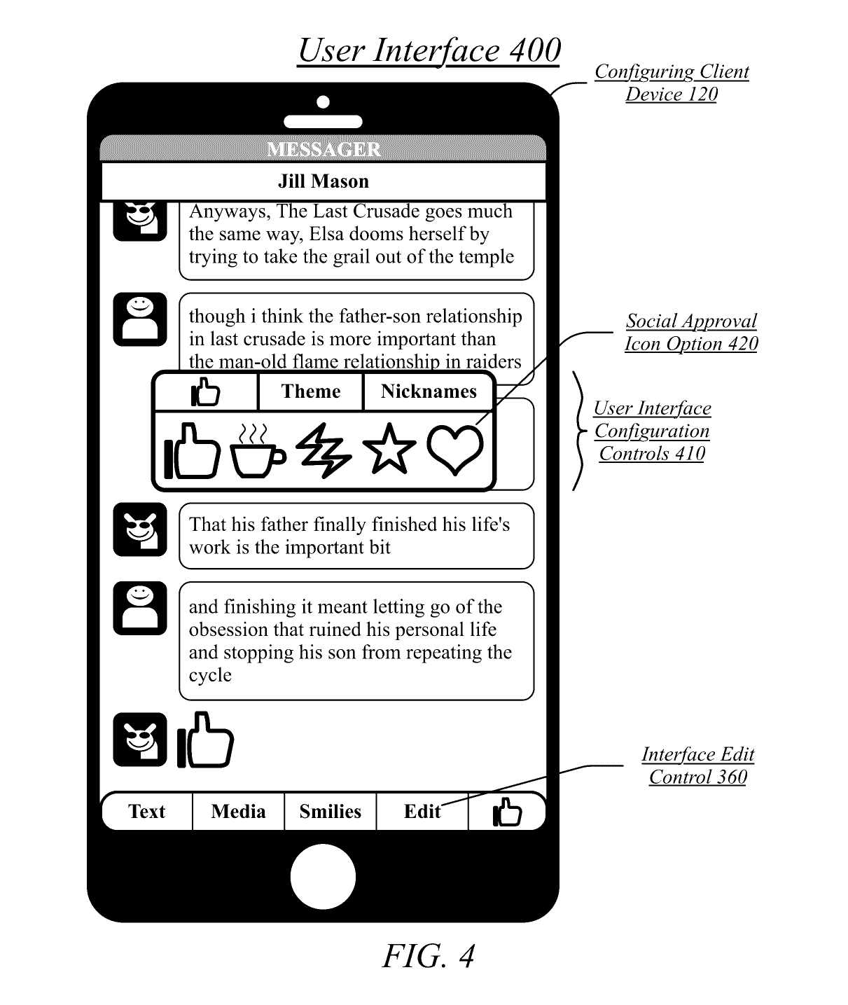

FIG. 4 illustrates an embodiment of a user interface 400 displaying user interface configuration controls 410.

Thread controls in a user interface 400 may include an interface edit control 360. An interface edit control 360, if selected by the user of the configuring client device 120, may initiate a display of user interface configuration controls 410 empowering the configuration of one or more user interface settings for the message thread.

In the illustrated embodiment of the user interface configuration controls 410 the user interface configuration controls 410 are showing social approval icon options, such as the heart comprising social approval icon option 420. A user of the configuring client device 120 may select a particular social approval icon from the plurality of available social approval icons. The messaging client may receive the user selection and configure the display of the message thread for all users associated with the message thread and on all client devices that display the message thread, which may, in some cases, include multiple clients devices for one or more users.

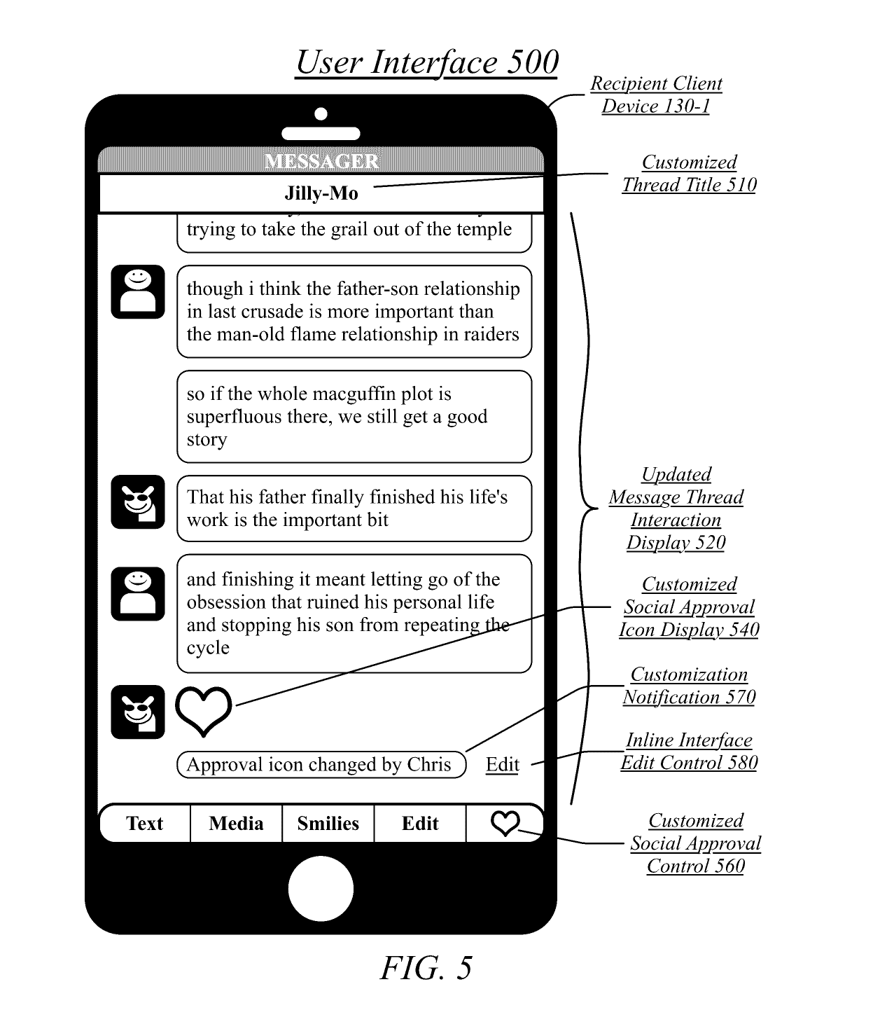

FIG. 5 illustrates an embodiment of a user interface 500 for a message thread with a customized social approval icon.

An updated message thread interaction display 520 represents a display of a message thread that has been updated in response to a message thread user interface setting being distributed by a configuring client device 120 to at least the recipient client device 130-1. In the illustrated embodiment, the social approval icon has been changed to be a heart. A customized social approval control 560 now displays the configured social approval icon, providing a preview of the social approval icon that will be used for the message thread. A customized social approval icon display 540 similarly uses the selected social approval icon. In some embodiments, only uses of the social approval icon after the customization may use the customized icon. In other embodiments, all uses of the social approval icon in the message thread may be changed, include the retroactive changing of all social approval icons used in the thread, when displayed.

A customized thread title 510 may be used, the customized thread title 510 automatically using a nickname specified for a participant in the message thread whose name appears in the thread title. This customized thread title 510 may also be used to reference the message thread in a listing of message threads, such as in a mailbox or inbox display.

When an interface customization has been applied, a customization notification 570 may be displayed inline with the updated message thread interaction display 520, representing that one of the users' interaction with the message thread has been to customize the appearance of the message thread. The customization notification 570 may include both a statement of what user interface element has been customized and what user has performed the customization. This customization notification 570 may be displayed in association with an inline interface edit control 580. An inline interface edit control 580 may provide the same access to user interface configuration controls as described with reference to the interface edit control 360 as described in FIG. 3. The display of the inline interface edit control 580 may serve to remind the user that they may change any settings made by another user or that they may make additional, different changes. For example, a user assigned a nickname by another participant in a message thread may respond by setting a nickname for the other participant.

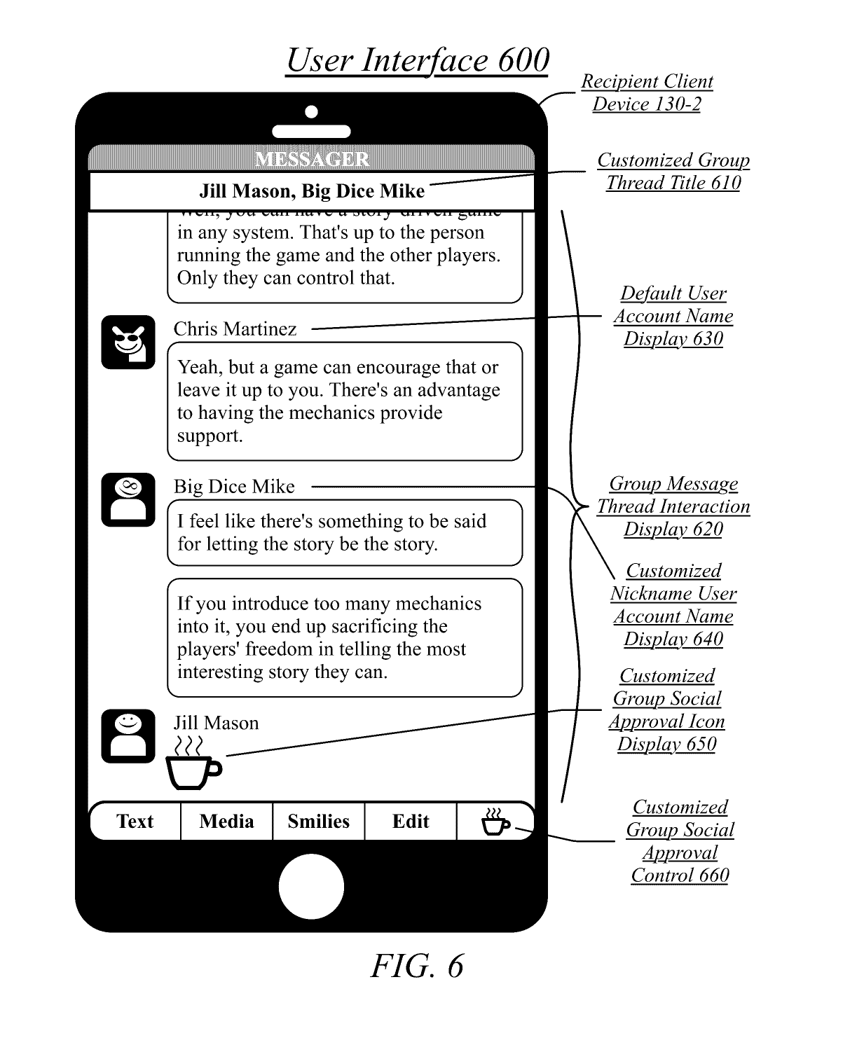

FIG. 6 illustrates an embodiment of a user interface 600 for a group message thread with a customized social approval icon and customized nickname.

A group message thread interaction display 620 may generally correspond to a one-on-one message thread interaction display 320. However, in some embodiments, additional user interface elements may be included. For instance, because the message thread is associated with multiple other users, each message exchange, message bubble, or sequence of message exchanges/message bubbles by a common user may be displayed with a display name for the sending user. Where no nickname has been specified for a user in association with the message thread, a default user account name display 630 may be used using the default user account name for the user account of the user. Where a nickname has been specified for a user in association with the message thread, the name used may be the customized nickname in a customized nickname user account name display 640. It will be appreciated that a per-message or per-message-sequence name display may be used in one-on-one threads in addition to with group threads. Similarly, the nickname may be used in a customized group thread title 610 displayed in association with the group thread in a user interface 600 for the group thread display or in an entry for the group thread in an inbox or mailbox.

As described with reference to a one-on-one message thread, a group message thread may have a customized social approval icon specified specifically for the group message thread. The customized social approval icon ma be used in a customized group social approval icon display 650 within the group message thread interaction display 620 and may be used as the icon for the customized group social approval control 660 as part of thread controls for the group thread.

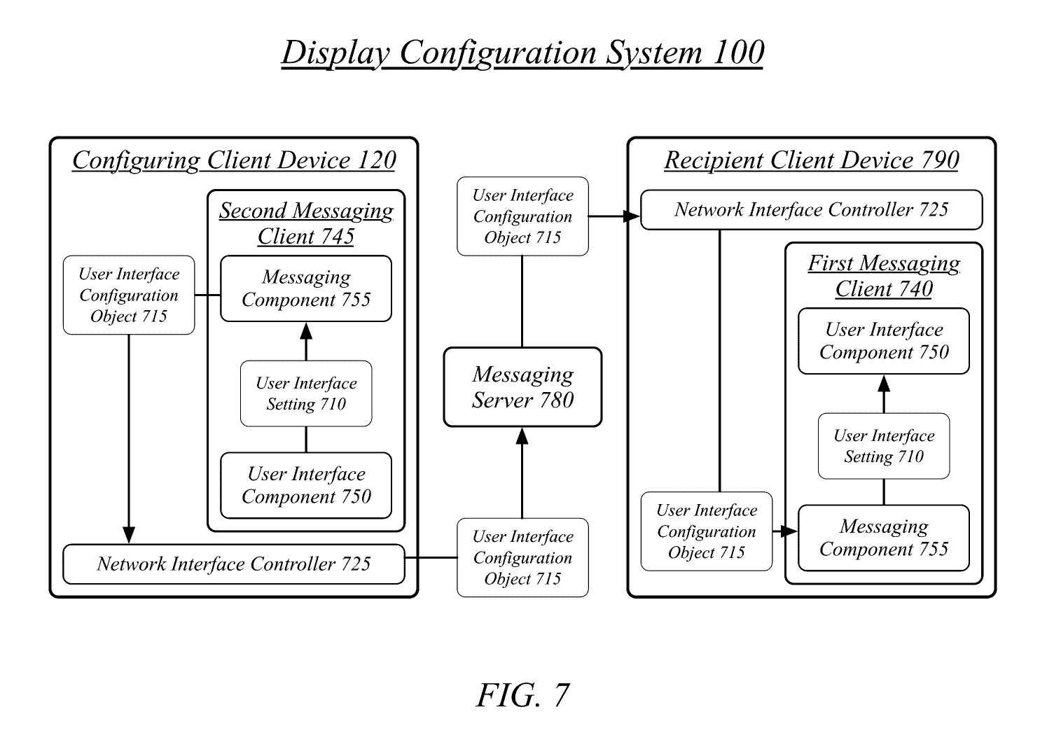

FIG. 7 illustrates an embodiment of a display configuration system transferring a user interface configuration setting between client devices.

A user's access to a display configuration system 100 may be a messaging client installed as a user application on a client device, such as configuring client device 120 or any of recipient client devices 130, to which recipient client device 790 may general correspond, and executing locally on the client device, such first messaging client 740 and second messaging client 745. In some cases, the first messaging client 740 and second messaging client 745 may comprise instances of a common messaging client application. In some cases, the messaging client may include other functionality. For example, the messaging client may be a front-end to a social-networking system 140, providing messaging services in association with the social-networking system 140. In many cases, a client device may be a smartphone, cell phone, or other mobile device using a mix of Wi-Fi and cellular data networks to access the Internet and networked resources, though it will be appreciated that any form of network access may be used. For example, one device may tether to another, such as a smart watch tethering to a Internet-capable device (e.g., mobile phone, personal computer) or a mobile phone tethering to a personal computer. A client device may execute a plurality of applications, including the messaging client. In other embodiments, however, the client device may comprise a personal computer device, a portable digital assistant, a tablet device, or any other form of computing device. Similarly, in some situations and embodiments, a user may access the messaging system 150 and/or social-networking system 140 via a web portal, with the messaging client executing as a web-based application.

A client device may communicate with other devices using wireless transmissions to exchange network traffic. Exchanging network traffic, such as may be included in the exchange of messaging transactions, may comprise transmitting and receiving network traffic via a network interface controller 725 (NIC). A NIC comprises a hardware component connecting a computer device, such as client device, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API). The network interface controller 725 may be used for the network activities of the embodiments described herein, including the interoperation of the messaging client and messaging server 780 through network communication. For example, the messaging client transmitting or receiving a user interface configuration object 715 to or from a messaging server 780 may be interpreted as using the network interface controller 725 for network access to a communications network for the transmission or reception of information.

The messaging client may comprise a user interface component 750. The user interface component 750 may be generally arranged to provide interfaces to the functionality of the messaging client. For instance, the user interface component 750 may provide interfaces to message viewing, message composition, message sending, and other messaging functions. In general, the user interface component 750 may provide interfaces for any functionality of the messaging client.

Determining the selection of a control, area, or other element of a user interface may comprise receiving an interrupt, API call, signal, or other indication from an interface library and/or operating system of a client device. The user interface component 750 may be operative to receive user interface interactions from the operating system and to translate these user interface interactions into the activation of various user interface elements. In some embodiments, various user interface elements may be registered with an interface library and/or operating system, with the interface library and/or operating system providing user interface interactions in reference to particular user interface elements.

The messaging client may comprise a messaging component 755. The messaging component 755 may be generally arranged to provide messaging services to a user of the client device. Messaging services may comprise the reception of messages, the sending of messages, the maintenance of a history of messages exchanged, and other messaging-related activities. User of the messaging client may be empowered to engage in messaging conversations with a plurality of other users in both private user-to-user conversations, in private group conversations between three or more users, and in public conversations generally open to the messaging community. The messaging component 755 may expose this functionality to the user using the user interface component 750.

The display configuration system 100 may interact with messaging servers from among a plurality of messaging servers, such as messaging server 780. A messaging server 780 may operate as an intermediary between the messaging endpoints of users of the messaging system 150. Messaging servers may track the current network address of a user's active messaging endpoint or endpoints, such as they change network (e.g., a mobile client device moving between Wi-Fi networks, between cellular data networks, and between Wi-Fi and cellular data networks). Messaging servers may queue messages for messaging endpoints when they are offline or otherwise not accepting new messages. Messaging servers may provide an ordering on messages for a particular user so as to provide consistency in the flow of communication between the potentially multiple messaging endpoints that a user might use. Messaging servers may store a messaging history for each user so as to provide access to previously-sent or received messages for a user. The messaging history may include media exchanged between users using the messaging system 150.

A first messaging client 740 on the recipient client device 790 may be associated with a first user account with the messaging system 150. A second messaging client 745 on the configuring client device 120 may be associated with a second user account with the messaging system 150. The user interface component 750 of the second messaging client 745 may be used to specify a user interface setting 710. The messaging component 755 of the second messaging client 745 may generate a user interface configuration object 715. The user interface configuration object 715 may represent one or more user interface settings for a message thread. In some instances, a user may specify a plurality of user interface settings and have the plurality of user interface settings communicated via a user interface configuration object and applied at all devices participating in a message thread. The messaging component 755 may transmit the user interface configuration object 715 via the network interface control 725 to the messaging server 780, the messaging server 780 then responsible for distributing the user interface configuration object 715 to all relevant client devices. The user interface configuration object 715 may be added to one or more message queues maintained for message exchange and distributed based on client device retrieval of message queue entries.

The messaging component 755 of the first messaging client 740 on the recipient client device 790 may be generally arranged to receive a user interface configuration object 715 from the messaging system 150 via a messaging server 780. The user interface configuration object may indicate the user interface setting 710 specified at the second messaging client on the second client device. The user interface component 750 for the first messaging client 740 may store the user interface setting 710 in association with a message thread associated with the first user account and the second user account. In some embodiments, each thread may be associated with a global thread identifier, with the user interface configuration object specifying the thread identifier for the thread that it encodes one or more user interface settings for. The user interface component 750 may display a message thread interface for the message thread based on the user interface setting. The user interface configuration object may indicate one or more user interface settings, the one or more user interface settings specifying one or more of background color, background image, background video, background text, bubble color, visual theme, nickname, and social approval icon, without limitation.

The message thread interface may comprise a social approval control. The message thread interface may comprise a message thread interaction display. The user interface setting may specify a social approval icon. The user interface component 750 on the recipient client device 790 may display the social approval control using the social approval icon and receive a user activation on the recipient client device 790 of the social approval control. The messaging component 755 may transmit a social approval command to the configuring client device 120 via the messaging system 150. And the user interface component 750 may display the social approval icon in the message thread interaction display based on the user activation of the social approval control on the recipient client device 790. The customized social approval icon may then be displayed on the configuring client device 120.

In some embodiments, particularly where a significant number of social approval icons are available, a messaging client may not have all of the available social approval icons downloaded to it. As such, in some embodiments the messaging component 755 of the first messaging client 740 on the recipient client device 790 may receive a network transmission of an image encoding of the social approval icon in association with the receiving of the user interface setting. Receiving the network transmission of the image encoding in association with the receiving of the user interface setting may comprise receiving the image encoding in the user interface configuration object 715. In other embodiments, receiving the transmission of the image encoding in association with the receiving of the user interface setting may comprising an identifier or resource locator for the social approval icon, empowering the first messaging client 740 to download the social approval icon from the messaging system 150 or other network-accessible system. However, in some instances, the social approval icon may already be present on the recipient client device 790, such as part of preloading by the display configuration system 100 or as part of a social approval icon search performed by a user of the recipient client device 790.

The message thread interface may comprise a message thread interaction display. A message thread interaction display may comprise a user name display for the first user account. The user interface setting may specify a nickname for the first user account. This nickname for the first user account is specific to the message thread. While a same nickname may be used for multiple threads, a nickname setting is a setting specific to a particular thread. The user interface component 750 may display the user name display for the first user account using the nickname for the first user account specified by the user interface setting.

The message thread interface may comprise a message thread interaction display. The user interface component 750 may display a user interface configuration change notification in the message thread interaction display in response to receiving the user interface setting 710. The user interface component 750 may display a user interface configuration edit control in association with the user interface configuration change notification in the message thread interaction display.

In some embodiments, various user interface settings may be promoted or suggested by the display configuration system 100 based on a information known about the participating users. The user interface component 750 may display a user interface configuration edit control and receive a user activation of the user interface configuration edit control. The display configuration system 100 may determine a plurality of suggested user interface settings based on relationship information between the first user account and second user account. The user interface component 750 may display the plurality of suggested user interface settings.

Relationship information may indicate, for instance, that two users are in a romantic relationship and, therefore, relationship-related icons (e.g., a heart, kissing lips) may be suggested. Relationship information may indicate a work relationship or shared occupation and, therefore, professional-related icons (e.g., a gavel for a pair of lawyers) may be suggested. In general, icons may be associated with one or more keywords, relationship types, or other relationship indicators, with icons suggested to a user where the icons match relationship indicators between the user and one or more other users in a message thread.

In general, interface customization elements may be associated with one or more indicators in a social-networking system 140 and the interface customization elements promoted where an indicator matches the user and/or other users in a message thread. Indicators associated with a relationship may relate to a messaging history for a messaging thread associated with the relationship, such as in the one-on-one message thread between the users. Indicators associated with two or more users in a message thread may relate to the message history for the group thread. For example, users discussing a sporting event may be suggested an interface customization element that corresponds to the sporting event, such as a baseball-shape social approval icon in a message thread in which the recent message thread history contains keywords related to a baseball playoff series.

Interface customization elements may be associated with events, locations, and other external factors. A user may be suggested interface customization elements based on these external factors, particularly where a relationship exists between one or more users and the external factors. For instance, a user may be suggested an interface customization elements based on their location, particularly where that location matches both users in a one-on-one message thread or all or most or some threshold percentage of users in a group message thread. For example, a social approval icon representing an iconic building in a city or a background image containing the logo for a local sports team. Similarly, interface customization elements related to an ongoing event may be promoted, such as a holiday-themed icon, background, etc. during the proximate time of the holiday. These techniques may be combined, such as an interface customization elements being increased in prominence based on the combination of it being related to an ongoing event and being relevant to a conversation.

In general, interface customization elements may be weighted based on one or more factors by the display configuration system 100. These factors may include thread messaging history, user messaging history, user relationships, and any other information known about a user and/or thread. Each factor may be considered and each contribute to a weight for the interface customization elements. The most heavily-weighted interface customization elements may then be suggested to a user, such as in response to a request to customize a message thread. A particular number of suggested interface customization elements may be predefined, with the predefined number of the most heavily-weighted elements selected for suggestion to the user.

In some embodiments, a social-networking system 140 may maintain relationship information for users of the social-networking system 140. One element of relationship information may comprise a relationship engagement measure indicating a strength, closeness, or other magnitude of a relationship between two or more users. The customization of a message thread between users may indicate that the users have a significant relationship due to at least one of the users customizing the message thread. The user interface component 750 may receive a user selection of a selected user interface setting of a plurality of suggested user interface settings. The messaging component 755 may register a relationship engagement indicator with the messaging system based on the user selection of the selected user interface setting. This relationship engagement indicator may cause the weight of the relationship to be increased for at least the configuring user (and therefore their user account) and, in some embodiments, both users (and therefore both user accounts).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

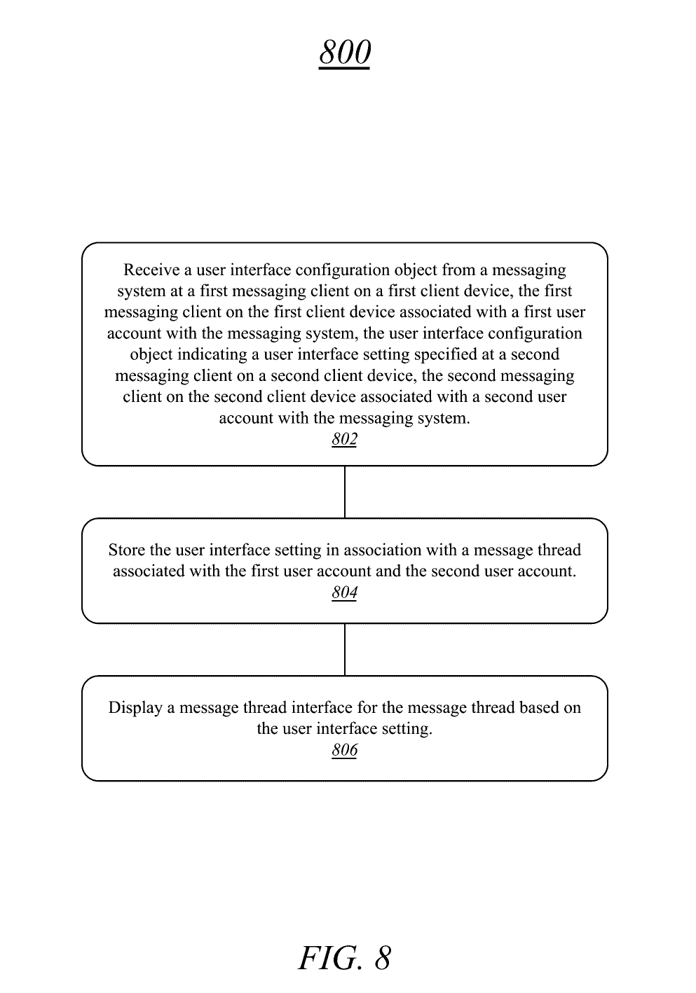

FIG. 8 illustrates one embodiment of a logic flow 800. The logic flow 800 may be representative of some or all of the operations executed by one or more embodiments described herein.

In the illustrated embodiment shown in FIG. 8, the logic flow 800 may receive a user interface configuration object from a messaging system at a first messaging client on a first client device, the first messaging client on the first client device associated with a first user account with the messaging system, the user interface configuration object indicating a user interface setting specified at a second messaging client on a second client device, the second messaging client on the second client device associated with a second user account with the messaging system at block 802.

The logic flow 800 may store the user interface setting in association with a message thread associated with the first user account and the second user account at block 804.

The logic flow 800 may display a message thread interface for the message thread based on the user interface setting at block 806.

The embodiments are not limited to this example.

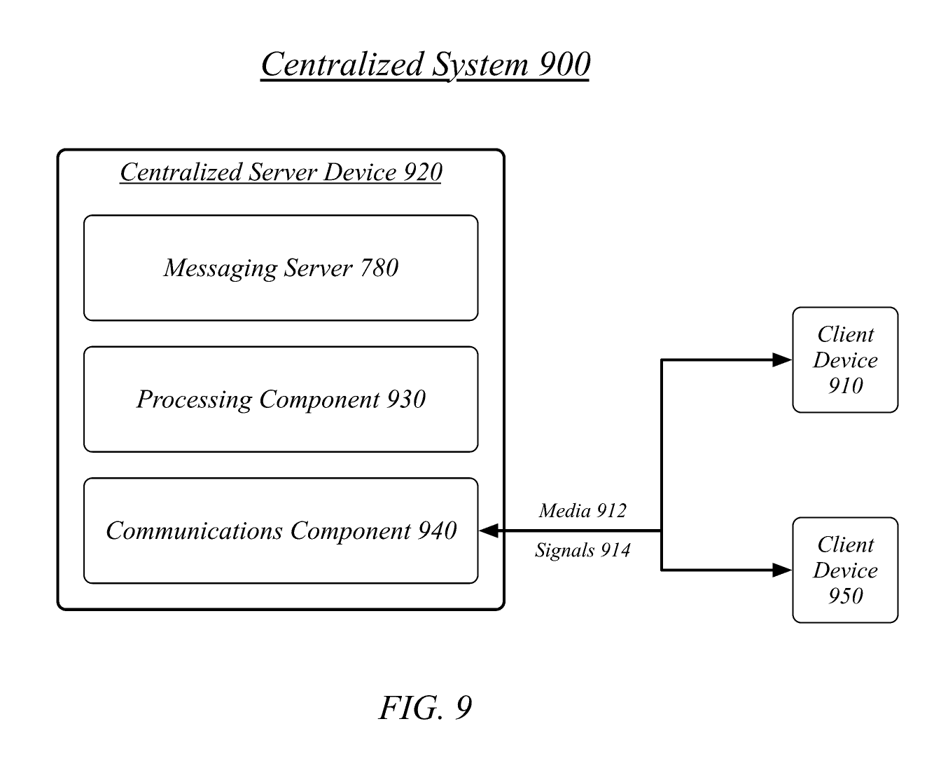

FIG. 9 illustrates a block diagram of a centralized system 900. The centralized system 900 may implement some or all of the structure and/or operations for the display configuration system 100 in a single computing entity, such as entirely within a single centralized server device 920.

The centralized server device 920 may comprise any electronic device capable of receiving, processing, and sending information for the display configuration system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The centralized server device 920 may execute processing operations or logic for the display configuration system 100 using a processing component 930. The processing component 930 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The centralized server device 920 may execute communications operations or logic for the display configuration system 100 using communications component 940. The communications component 940 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 940 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 912 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The centralized server device 920 may communicate with client devices 910, 950 over a communications media 912 using communications signals 914 via the communications component 940. The client devices 910, 950 may be internal or external to the centralized server device 920 as desired for a given implementation.

The centralized system 900 may correspond to an embodiment in which a single messaging server 190 is used executing on a single centralized server device 920. The client devices 910, 950 may correspond to client devices—such as configuring client device 120, recipient client devices 130, and recipient client device 790—using the messaging server 780 for messaging services.

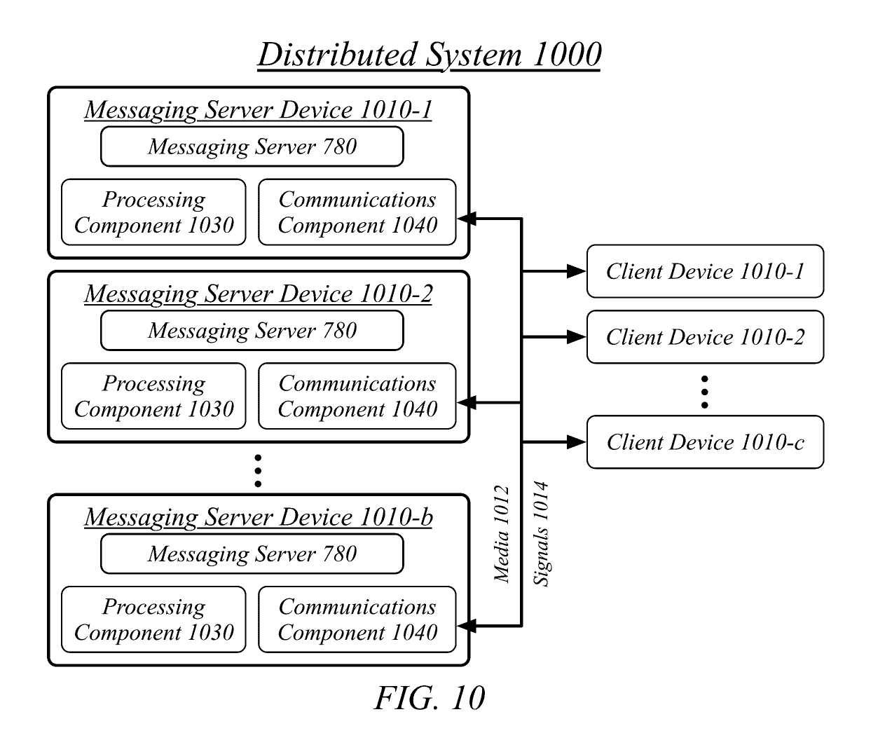

FIG. 10 illustrates a block diagram of a distributed system 1000. The distributed system 1000 may distribute portions of the structure and/or operations for the display configuration system 100 across multiple computing entities. Examples of distributed system 1000 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1000 may comprise a plurality of messaging server device 1010. In general, the server devices 1010 may be the same or similar to the centralized server device 920 as described with reference to FIG. 9. For instance, the server devices 1010 may each comprise a processing component 1030 and a communications component 1040 which are the same or similar to the processing component 930 and the communications component 940, respectively, as described with reference to FIG. 9. In another example, the server devices 1010 may communicate over a communications media 1012 using communications signals 1014 via the communications components 1040.

The plurality of messaging server devices 1010 may comprise or employ one or more server programs that operate to perform various methodologies in accordance with the described embodiments. In one embodiment, for example, the plurality of messaging server devices 1010 may collectively implement the messaging server 780 as a distributed messaging server 780. Each of the messaging server devices 1010 may execute a messaging server 780 to collectively provide messaging services to the users of the display configuration system 100.

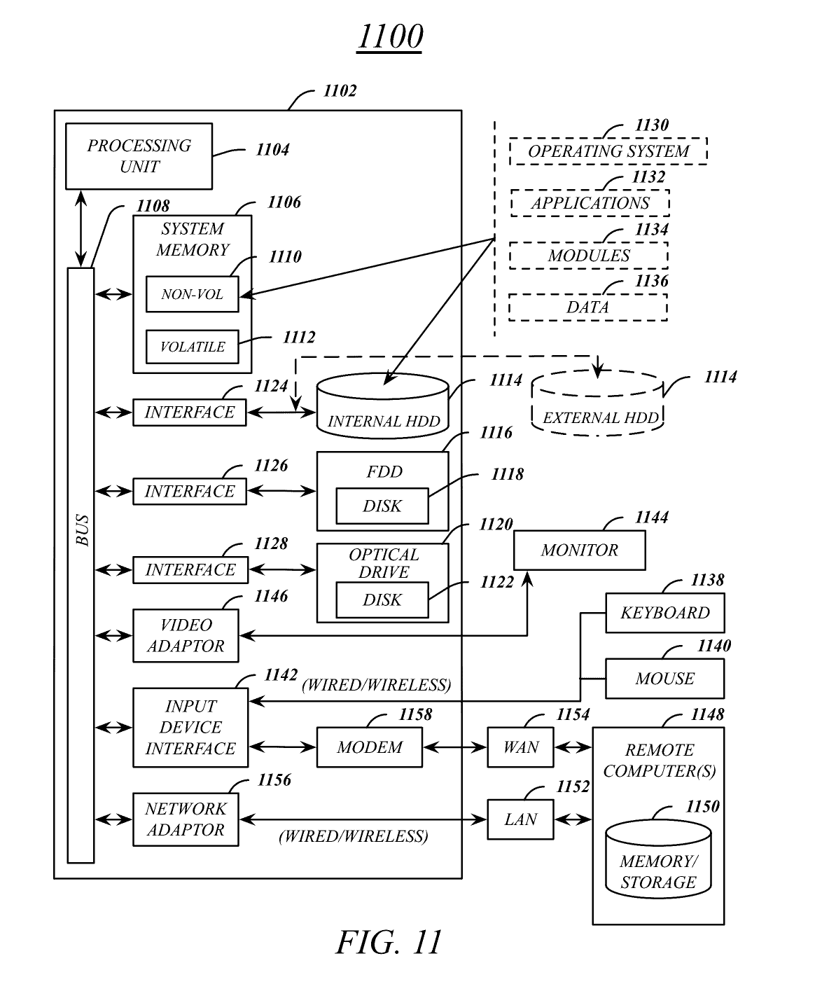

FIG. 11 illustrates an embodiment of an exemplary computing architecture 1100 suitable for implementing various embodiments as previously described. In one embodiment, the computing architecture 1100 may comprise or be implemented as part of an electronic device. Examples of an electronic device may include those described with reference to FIG. 1, 7, 9, 10, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1100.

As shown in FIG. 11, the computing architecture 1100 comprises a processing unit 1104, a system memory 1106 and a system bus 1108. The processing unit 1104 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1104.

The system bus 1108 provides an interface for system components including, but not limited to, the system memory 1106 to the processing unit 1104. The system bus 1108 can be any of several types of bus structure that may further interconnect to a memory bus (with or without a memory controller), a peripheral bus, and a local bus using any of a variety of commercially available bus architectures. Interface adapters may connect to the system bus 1108 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1100 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1106 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 11, the system memory 1106 can include non-volatile memory 1110 and/or volatile memory 1112. A basic input/output system (BIOS) can be stored in the non-volatile memory 1110.

The computer 1102 may include various types of computer-readable storage media in the form of one or more lower speed memory units, including an internal (or external) hard disk drive (HDD) 1114, a magnetic floppy disk drive (FDD) 1116 to read from or write to a removable magnetic disk 1118, and an optical disk drive 1120 to read from or write to a removable optical disk 1122 (e.g., a CD-ROM or DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1110, 1112, including an operating system 1130, one or more application programs 1132, other program modules 1134, and program data 1136. In one embodiment, the one or more application programs 1132, other program modules 1134, and program data 1136 can include, for example, the various applications and/or components of the display configuration system 100.

A user can enter commands and information into the computer 1102 through one or more wire/wireless input devices, for example, a keyboard 1138 and a pointing device, such as a mouse 1140. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, and so forth.

A monitor 1144 or other type of display device is also connected to the system bus 1108 via an interface, such as a video adaptor 1146. The monitor 1144 may be internal or external to the computer 1102. In addition to the monitor 1144, a computer typically includes other peripheral output devices, such as speakers, printers, and so forth.

The computer 1102 may operate in a networked environment using logical connections via wire and/or wireless communications to one or more remote computers, such as a remote computer 1148. The remote computer 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, connects to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

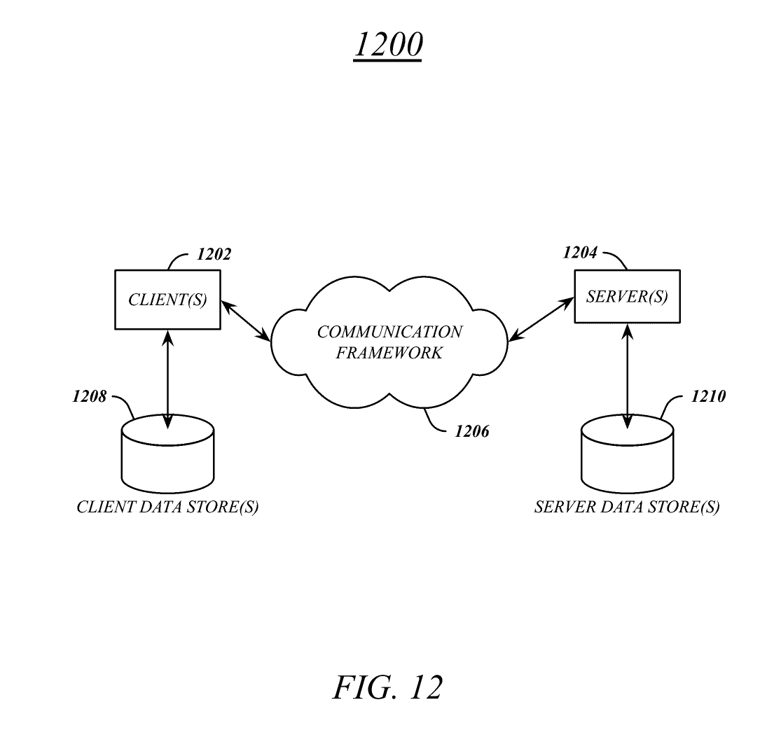

FIG. 12 illustrates a block diagram of an exemplary communications architecture 1200 suitable for implementing various embodiments as previously described. The communications architecture 1200 includes various common communications elements, such as a transmitter, receiver, transceiver, radio, network interface, baseband processor, antenna, amplifiers, filters, power supplies, and so forth. The embodiments, however, are not limited to implementation by the communications architecture 1200.

As shown in FIG. 12, the communications architecture 1200 comprises includes one or more clients 1202 and servers 1204. The clients 1202 may implement the client devices 120, 130, 790, 910, 950. The servers 1204 may implement the messaging server devices 1010. The clients 1202 and the servers 1204 are operatively connected to one or more respective client data stores 1208 and server data stores 1210 that can be employed to store information local to the respective clients 1202 and servers 1204, such as cookies and/or associated contextual information.

The clients 1202 and the servers 1204 may communicate information between each other using a communication framework 1206. The communications framework 1206 may implement any well-known communications techniques and protocols. The communications framework 1206 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1206 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1202 and the servers 1204. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

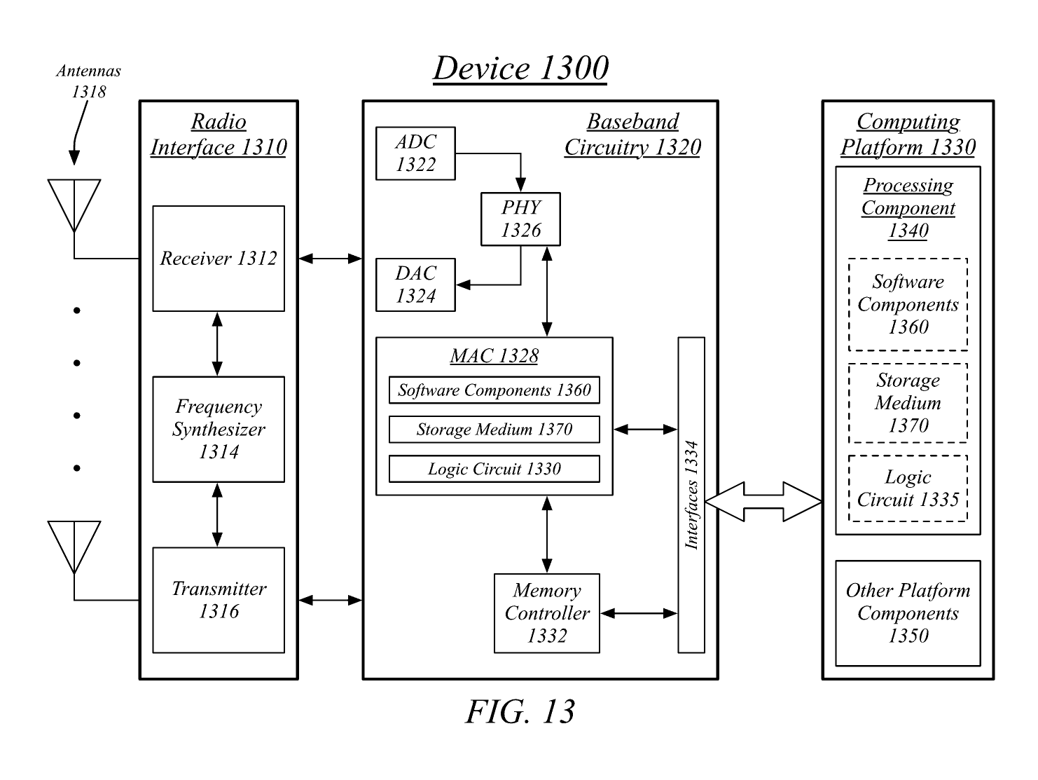

FIG. 13 illustrates an embodiment of a device 1300 for use in a multicarrier OFDM system, such as the display configuration system 100. Device 1300 may implement, for example, software components 1360 as described with reference to display configuration system 100 and/or a logic circuit 1335. The logic circuit 1335 may include physical circuits to perform operations described for the display configuration system 100. As shown in FIG. 13, device 1300 may include a radio interface 1310, baseband circuitry 1320, and computing platform 1330, although embodiments are not limited to this configuration.

The device 1300 may implement some or all of the structure and/or operations for the display configuration system 100 and/or logic circuit 1335 in a single computing entity, such as entirely within a single device. Alternatively, the device 1300 may distribute portions of the structure and/or operations for the display configuration system 100 and/or logic circuit 1335 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1310 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1310 may include, for example, a receiver 1312, a transmitter 1316 and/or a frequency synthesizer 1314. Radio interface 1310 may include bias controls, a crystal oscillator and/or one or more antennas 1318. In another embodiment, radio interface 1310 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1320 may communicate with radio interface 1310 to process receive and/or transmit signals and may include, for example, an analog-to-digital converter 1322 for down converting received signals, a digital-to-analog converter 1324 for up converting signals for transmission. Further, baseband circuitry 1320 may include a baseband or physical layer (PHY) processing circuit 1356 for PHY link layer processing of respective receive/transmit signals. Baseband circuitry 1320 may include, for example, a processing circuit 1328 for medium access control (MAC)/data link layer processing. Baseband circuitry 1320 may include a memory controller 1332 for communicating with processing circuit 1328 and/or a computing platform 1330, for example, via one or more interfaces 1334.

In some embodiments, PHY processing circuit 1326 may include a frame construction and/or detection module, in combination with additional circuitry such as a buffer memory, to construct and/or deconstruct communication frames, such as radio frames. Alternatively or in addition, MAC processing circuit 1328 may share processing for certain of these functions or perform these processes independent of PHY processing circuit 1326. In some embodiments, MAC and PHY processing may be integrated into a single circuit.

The computing platform 1330 may provide computing functionality for the device 1300. As shown, the computing platform 1330 may include a processing component 1340. In addition to, or alternatively of, the baseband circuitry 1320, the device 1300 may execute processing operations or logic for the display configuration system 100 and logic circuit 1335 using the processing component 1340. The processing component 1340 (and/or PHY 1326 and/or MAC 1328) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1330 may further include other platform components 1350. Other platform components 1350 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1300 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1300 described herein, may be included or omitted in various embodiments of device 1300, as suitably desired. In some embodiments, device 1300 may be configured to be compatible with protocols and frequencies associated one or more of the 3GPP LTE Specifications and/or IEEE 1302.16 Standards for WMANs, and/or other broadband wireless networks, cited herein, although the embodiments are not limited in this respect.

Embodiments of device 1300 may be implemented using single input single output (SISO) architectures. However, certain implementations may include multiple antennas (e.g., antennas 1318) for transmission and/or reception using adaptive antenna techniques for beamforming or spatial division multiple access (SDMA) and/or using MIMO communication techniques.

The components and features of device 1300 may be implemented using any combination of discrete circuitry, application specific integrated circuits (ASICs), logic gates and/or single chip architectures. Further, the features of device 1300 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1300 shown in the block diagram of FIG. 13 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

A computer-implemented method may comprise receiving a user interface configuration object from a messaging system at a first messaging client on a first client device, the first messaging client on the first client device associated with a first user account with the messaging system, the user interface configuration object indicating a user interface setting specified at a second messaging client on a second client device, the second messaging client on the second client device associated with a second user account with the messaging system; storing the user interface setting in association with a message thread associated with the first user account and the second user account; and displaying a message thread interface for the message thread based on the user interface setting.

A computer-implemented method may further comprise the message thread interface comprising a social approval control, the message thread interface comprising a message thread interaction display, the user interface setting specifying a social approval icon, further comprising: displaying the social approval control using the social approval icon; receiving a user activation on the first client device of the social approval control; transmitting a social approval command to the second client device via the messaging system; and displaying the social approval icon in the message thread interaction display.

A computer-implemented method may further comprise receiving a network transmission of an image encoding of the social approval icon in association with the receiving of the user interface setting.

A computer-implemented method may further comprise the user interface configuration object indicating one or more user interface settings, the one or more user interface settings specifying one or more of background color, background image, background video, background text, bubble color, and visual theme.

A computer-implemented method may further comprise the message thread interface comprising a message thread interaction display, the message thread interaction display comprising a user name display for the first user account, the user interface setting specifying a nickname for the first user account, the nickname for the first user account specific to the message thread, further comprising: displaying the user name display for the first user account using the nickname for the first user account specified by the user interface setting.

A computer-implemented method may further comprise the message thread interface comprising a message thread interaction display, further comprising: displaying a user interface configuration change notification in the message thread interaction display; and displaying a user interface configuration edit control in association with the user interface configuration change notification in the message thread interaction display.

A computer-implemented method may further comprise displaying a user interface configuration edit control; receiving a user activation of the user interface configuration edit control; determining a plurality of suggested user interface settings based on relationship information between the first user account and second user account; and displaying the plurality of suggested user interface settings.

A computer-implemented method may further comprise receiving a user selection of a selected user interface setting of the plurality of suggested user interface settings; and registering a relationship engagement indicator with the messaging system based on the user selection of the selected user interface setting.

An apparatus may comprise a processor circuit on a first client device; a network interface controller on the first client device; a messaging component operative on the processor circuit to receive a user interface configuration object from a messaging system at a first messaging client on the first client device via the network interface controller, the first messaging client on the first client device associated with a first user account with the messaging system, the user interface configuration object indicating a user interface setting specified at a second messaging client on a second client device, the second messaging client on the second client device associated with a second user account with the messaging system; and a user interface component operative on the processor circuit to store the user interface setting in association with a message thread associated with the first user account and the second user account; and display a message thread interface for the message thread based on the user interface setting. The apparatus may be operative to implement any of the computer-implemented methods described herein.

At least one computer-readable storage medium may comprise instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
receiving a user interface configuration object from a messaging system at a first messaging client on a first client device, the first messaging client on the first client device associated with a first user account with the messaging system, the user interface configuration object indicating a user interface setting specified at a second messaging client on a second client device, the second messaging client on the second client device associated with a second user account with the messaging system;
storing the user interface setting in association with a message thread associated with the first user account and the second user account; and
displaying a message thread interface for the message thread based on the user interface setting.

2. The method of claim 1, the message thread interface comprising a social approval control, the message thread interface comprising a message thread interaction display, the user interface setting specifying a social approval icon, further comprising:
displaying the social approval control using the social approval icon;
receiving a user activation on the first client device of the social approval control;
transmitting a social approval command to the second client device via the messaging system; and
displaying the social approval icon in the message thread interaction display.

3. The method of claim 2, further comprising:
receiving a network transmission of an image encoding of the social approval icon in association with the receiving of the user interface setting.

4. The method of claim 1, the user interface configuration object indicating one or more user interface settings, the one or more user interface settings specifying one or more of background color, background image, background video, background text, bubble color, and visual theme.

5. The method of claim 1, the message thread interface comprising a message thread interaction display, the message thread interaction display comprising a user name display for the first user account, the user interface setting specifying a nickname for the first user account, the nickname for the first user account specific to the message thread, further comprising:
displaying the user name display for the first user account using the nickname for the first user account specified by the user interface setting.

6. The method of claim 1, the message thread interface comprising a message thread interaction display, further comprising:
displaying a user interface configuration change notification in the message thread interaction display; and
displaying a user interface configuration edit control in association with the user interface configuration change notification in the message thread interaction display.

7. The method of claim 1, further comprising:
displaying a user interface configuration edit control;
receiving a user activation of the user interface configuration edit control;
determining a plurality of suggested user interface settings based on relationship information between the first user account and second user account; and
displaying the plurality of suggested user interface settings.

8. The method of claim 7, further comprising:
receiving a user selection of a selected user interface setting of the plurality of suggested user interface settings; and
registering a relationship engagement indicator with the messaging system based on the user selection of the selected user interface setting.

9. An apparatus, comprising:
a processor circuit on a first client device;
a network interface controller on the first client device;
a messaging component operative on the processor circuit to receive a user interface configuration object from a messaging system at a first messaging client on the first client device via the network interface controller, the first messaging client on the first client device associated with a first user account with the messaging system, the user interface configuration object indicating a user interface setting specified at a second messaging client on a second client device, the second messaging client on the second client device associated with a second user account with the messaging system; and
a user interface component operative on the processor circuit to store the user interface setting in association with a message thread associated with the first user account and the second user account; and display a message thread interface for the message thread based on the user interface setting.

10. The apparatus of claim 9, the message thread interface comprising a social approval control, the message thread interface comprising a message thread interaction display, the user interface setting specifying a social approval icon, further comprising:
the user interface component operative to display the social approval control using the social approval icon; receive a user activation on the first client device of the social approval control; and display the social approval icon in the message thread interaction display; and
the messaging component operative to transmit a social approval command to the second client device via the messaging system.

11. The apparatus of claim 9, the user interface configuration object indicating one or more user interface settings, the one or more user interface settings specifying one or more of background color, background image, background video, background text, bubble color, and visual theme.

12. The apparatus of claim 9, the message thread interface comprising a message thread interaction display, the message thread interaction display comprising a user name display for the first user account, the user interface setting specifying a nickname for the first user account, the nickname for the first user account specific to the message thread, further comprising:
the user interface component operative to display the user name display for the first user account using the nickname for the first user account specified by the user interface setting.

13. The apparatus of claim 9, the message thread interface comprising a message thread interaction display, further comprising:
the user interface component operative to display a user interface configuration change notification in the message thread interaction display; and display a user interface configuration edit control in association with the user interface configuration change notification in the message thread interaction display.

14. The apparatus of claim 9, further comprising:
the user interface component operative to display a user interface configuration edit control; receive a user activation of the user interface configuration edit control; and display the plurality of suggested user interface settings; and
the messaging system operative to determine the plurality of suggested user interface settings based on relationship information between the first user account and second user account.

15. At least one computer-readable storage medium comprising instructions that, when executed, cause a system to:
receive a user interface configuration object from a messaging system at a first messaging client on a first client device, the first messaging client on the first client device associated with a first user account with the messaging system, the user interface configuration object indicating a user interface setting specified at a second messaging client on a second client device, the second messaging client on the second client device associated with a second user account with the messaging system;
store the user interface setting in association with a message thread associated with the first user account and the second user account; and
display a message thread interface for the message thread based on the user interface setting.

16. The computer-readable storage medium of claim 15, the message thread interface comprising a social approval control, the message thread interface comprising a message thread interaction display, the user interface setting specifying a social approval icon, comprising further instructions that, when executed, cause a system to:
display the social approval control using the social approval icon;
receive a user activation on the first client device of the social approval control;
transmit a social approval command to the second client device via the messaging system; and
display the social approval icon in the message thread interaction display.

17. The computer-readable storage medium of claim 15, the user interface configuration object indicating one or more user interface settings, the one or more user interface settings specifying one or more of background color, background image, background video, background text, bubble color, and visual theme.

18. The computer-readable storage medium of claim 15, the message thread interface comprising a message thread interaction display, the message thread interaction display comprising a user name display for the first user account, the user interface setting specifying a nickname for the first user account, the nickname for the first user account specific to the message thread, comprising further instructions that, when executed, cause a system to:
display the user name display for the first user account using the nickname for the first user account specified by the user interface setting.

19. The computer-readable storage medium of claim 15, the message thread interface comprising a message thread interaction display, comprising further instructions that, when executed, cause a system to:
display a user interface configuration change notification in the message thread interaction display; and
display a user interface configuration edit control in association with the user interface configuration change notification in the message thread interaction display.

20. The computer-readable storage medium of claim 15, comprising further instructions that, when executed, cause a system to:
display a user interface configuration edit control;
receive a user activation of the user interface configuration edit control;
determine a plurality of suggested user interface settings based on relationship information between the first user account and second user account; and
display the plurality of suggested user interface settings.
